(19) United States
(12) Patent Application Publication
(10) Pub. No.: US 2018/0089739 A1
(43) Pub. Date: Mar. 29, 2018

(54) PREDICTING USER PREFERENCES BASED ON OLFACTORY CHARACTERISTICS

(71) Applicant: International Business Machines Corporation, Armonk, NY (US)

(72) Inventors: Guillermo Cecchi, New York, NY (US); Amit Dhurandhar, Yorktown Heights, NY (US); Stacey M. Gifford, Ridgefield, CT (US); Raquel Norel, Bronx, NY (US); Pablo Meyer Rojas, New, NY (US); Kahn Rhrissorrakrai, Woodside, NY (US); Bo Zhang, Hoboken, NJ (US)

(21) Appl. No.: 15/278,692

(22) Filed: Sep. 28, 2016

(51) Int. Cl. G06Q 30/06; G06Q 50/00; G06N 5/02

(52) U.S. Cl. CPC G06Q 30/0631; G06N 5/022; G06Q 50/01

(57) ABSTRACT

Systems, methods, and computer-readable media are described for predicting consumer response to a stimulus based on olfactory characteristics of the stimulus. An intrinsic factor score associated with a product can be determined based on an intrinsic attribute of the stimulus, and optionally, further based on data indicative of historical consumer response to olfactory characteristics of the stimulus. A social factor score associated with a user can also be determined using available olfactory preference data associated with the user and/or data representative of one or more social signals indicative of a predicted response of the user to olfactory characteristics of the stimulus. A collaborative filtering technique can be employed to determine a recommendation score for the stimulus using the intrinsic factor score and the social factor score. The recommendation score can be compared to a threshold value to determine whether to recommend the stimulus to the user.

### BACKGROUND

The present invention relates generally to predicting user responses to stimuli, and more specifically, to predicting user responses to olfactory characteristics of stimuli.

Consumer products can exhibit various olfactory characteristics that elicit a variety of human responses. For example, a particular type of perfume can have a flowery scent that most consumers would find pleasing. In the alternative, another product such as a cleaning solution can have an odor that most consumers would find distasteful. Further, in certain scenarios, a product such as a particular food item can exhibit olfactory characteristics that elicit a spectrum of responses from a group of consumers ranging from consumers who find the product's taste or odor distasteful, to consumers who are indifferent towards the olfactory characteristics of the product, to consumers who find the product's taste or odor to be pleasant.

### SUMMARY

In one or more example embodiments of the invention, a method for predicting a response to a stimulus based on olfactory characteristics of the stimulus is described. The method includes determining an intrinsic factor score for the stimulus based at least in part on an intrinsic attribute of the stimulus. The method further includes determining a social factor score associated with a user, where the social factor score is indicative of a predicted response of the user to the olfactory characteristics of the stimulus. The method then includes determining a recommendation score for the stimulus with respect to the user based at least in part on the intrinsic factor score and the social factor score. The method additionally includes determining that the recommendation score satisfies a threshold value and sending, to a client application executing on a user device operable by the user, a message that recommends the stimulus to the user.

In one or more other example embodiments of the invention, a system for predicting a response to a stimulus based on olfactory characteristics of the stimulus is described. The system includes at least one memory storing computer-executable instructions and at least one processor configured to access the at least one memory and execute the computer-executable instructions to perform a set of operations. The operations include determining an intrinsic factor score for the stimulus based at least in part on an intrinsic attribute of the stimulus, and determining a social factor score associated with a user, where the social factor score is indicative of a predicted response of the user to the olfactory characteristics of the stimulus. The operations further include determining a recommendation score for the stimulus with respect to the user based at least in part on the intrinsic factor score and the social factor score. The operations additionally include determining that the recommendation score satisfies a threshold value and sending, to a client application executing on a user device operable by the user, a message that recommends the stimulus to the user.

In one or more other example embodiments of the invention, a computer program product for predicting a response to a stimulus based on olfactory characteristics of the stimulus is described. The computer program product includes a non-transitory storage medium readable by a processing circuit, where the storage medium stores instructions executable by the processing circuit to cause a method to be performed. The method includes determining an intrinsic factor score for the stimulus based at least in part on an intrinsic attribute of the stimulus. The method further includes determining a social factor score associated with a user, where the social factor score is indicative of a predicted response of the user to the olfactory characteristics of the stimulus. The method then includes determining a recommendation score for the stimulus with respect to the user based at least in part on the intrinsic factor score and the social factor score. The method additionally includes determining that the recommendation score satisfies a threshold value and sending, to a client application executing on a user device operable by the user, a message that recommends the stimulus to the user.

### BRIEF DESCRIPTION OF THE DRAWINGS

The detailed description is set forth with reference to the accompanying drawings. The drawings are provided for purposes of illustration only and merely depict example embodiments of the invention. The drawings are provided to facilitate understanding of embodiments of the invention and shall not be deemed to limit the breadth, scope, or applicability of embodiments of the invention. In the drawings, the left-most digit(s) of a reference numeral identifies the drawing in which the reference numeral first appears. The use of the same reference numerals indicates similar, but not necessarily the same or identical components. However, different reference numerals can be used to identify similar components as well. Various embodiments can utilize elements or components other than those illustrated in the drawings, and some elements and/or components can be absent in various embodiments. The use of singular terminology to describe a component or element can, depending on the context, encompass a plural number of such components or elements and vice versa.

FIG. 1 is a schematic data flow and block diagram depicting the generation of a product recommendation score for a product with respect to a user based on intrinsic olfactory characteristics of the product as well as extrinsic factors predictive of the user's olfactory response to the product in accordance with one or more example embodiments of the invention.

FIG. 2 is a process flow diagram of an illustrative method for generating and presenting a product recommendation score for a product to a user in accordance with one or more example embodiments of the invention.

FIG. 3 is a process flow diagram of an illustrative method for refining a predicted olfactory response to a product using user feedback data in accordance with one or more example embodiments of the invention.

FIG. 4 is a schematic diagram of an illustrative networked architecture in accordance with one or more example embodiments of the invention.

### DETAILED DESCRIPTION

Example embodiments of the invention include, among other things, systems, methods, computer-readable media, techniques, and methodologies for predicting consumer response to a stimulus based at least in part on olfactory characteristics of the stimulus. An intrinsic factor score associated with the stimulus can be determined based at least in part on an intrinsic attribute of the stimulus. In those example embodiments in which the stimulus is a product, the intrinsic attribute can be a chemical structure of the product. The intrinsic factor score can optionally be further determined based at least in part on data indicative of historical consumer response to olfactory characteristics of the stimulus. The intrinsic factor score can be a measure of a predicted consumer response in the aggregate to olfactory characteristics inherent to the stimulus (e.g., olfactory characteristics that are a result of a product's chemical structure/makeup).

A social factor score associated with a user can also be determined using available olfactory preference data associated with the user and/or data representative of one or more social signals indicative of a predicted response of the user to olfactory characteristics of the stimulus. A collaborative filtering technique can be employed to determine a recommendation for the product with respect to the user using the intrinsic factor score and the social factor score. The recommendation score can be compared to a threshold value to determine whether to recommend the stimulus to the user. The stimulus can be a product, a service, or an environment. However, for ease of explanation, and without limitation, example embodiments will be described herein in connection with a stimulus that is a product.

In an example scenario to which example embodiments of the invention are applicable, a user visits a coffee shop that offers a variety of different coffee roast options from which to select. The options can include different bean species, different bean varieties, different manufacturers, different roast types, and so forth. The user can utilize a client application executing on a client device (e.g., a mobile application executing on a mobile device) to capture an image of a particular coffee product. The client application can utilize text and/or image recognition to identify the product in the image. Alternatively, the user can scan a barcode of the product, and the client application can identify the product based on the barcode.

A prediction as to whether the user will find the selected coffee product desirable based on its olfactory characteristics can then be made. In particular, as will be described in more detail later in this description, an intrinsic factor score can be determined for the product based at least in part on its chemical structure, and a social factor score can be determined for the user based at least in part on user olfactory preference data associated with the user (e.g., previous ratings provided by the user of olfactory characteristics of products) and/or other social signal data. These scores can together be used to determine a product recommendation score for the selected coffee product with respect to the user. The product recommendation score can be presented to the user to provide the user with an indication of the likelihood that he/she will find olfactory characteristics of the product desirable. In certain example embodiments, the various engines configured to determine these scores can form part of the client application or can execute on one or more servers with which the client application is configured to communicate. Further, in certain example embodiments, a server may send a message recommending the selected coffee product to the user to the client application executing on the user device operable by the user. The message may contain the recommendation score. In particular, in certain example embodiments, the client application may be logged into a user profile associated with the user and the recommendation score may be accessible via the user profile.

The user can choose to drink or simply smell the selected coffee product. The user can then utilize the client application to provide a rating of olfactory characteristics of the product. For example, the user can utilize a predetermined set of descriptors or can specify one or more descriptors independently to associate olfactory characteristics with the product. This user feedback data can then be used to refine the intrinsic factor score and/or the social factor score. In this manner, the client application can be used to catalog olfactory characteristics of various coffee products that the user has sampled and to receive recommendations for new coffee products. In certain example embodiments, the client application can incorporate game playing principles to the user rating activities to increase the signal data acquired for the user.

Example embodiments of the invention for predicting consumer response to olfactory characteristics of a product can provide a number of benefits across a wide range of industries. Tastes and odors that impact human olfactory senses and human behavior are omnipresent in the environment generally and in consumer products in particular. Odors, for example, can serve as powerful stimuli. For instance, the aroma/smell of a cup of coffee can produce a comparable stimulus effect as drinking the coffee.

Further, while many odors are harmless or even beneficial, some are indicative of pathogens that can cause disease or illness. A common route for transmission of infectious diseases is by contact with surfaces contaminated with infectious bacteria from an infected individual. Many microbes can not only survive for days on surfaces but can profilerate, posing even greater safety and health risks. Various odors can serve as indicators of such microbes. In addition, odors can have a significant impact on public health. For example, studies have shown that usage of restrooms in many underdeveloped nations is negatively correlated with the presence of unpleasant odors.

Certain odors are also linked to memory formation and retrieval. For example, an individual can associate an odor with a particular positive or negative memory, which can impact the emotions elicited in the individual by exposure to the odor. This linkage between odors and memory formation and retrieval can greatly impact an individual's perception of objects, foods, and environments in a highly personal manner.

Example embodiments of the invention can provide manufacturers or other interested entities with valuable information regarding an association between an object's olfactory characteristics and predicted human responses to those characteristics, thereby allowing these entities to engage in more targeted olfactory branding. For example, manufacturers can utilize example embodiments of the invention to enhance the marketing appeal of their products based on odors they emanate. As another example, manufacturers can extend the predictive capabilities of example embodiments of the invention to develop new products or new scents that are customized to particular users or user groups. As yet another example, organizations that desire to gather people within a retail or event space can take the scent of the space into account as a design consideration.

Other potential benefits of example embodiments of the invention include providing analytics to manufacturers or other industry participants to improve the sales and development of its offerings; identifying local, cultural, and temporal trends to aid in product design, marketing, and olfactory branding; targeting industries or specific products to particular consumers; bridging expert ontology for describing olfactory characteristics of a product with consumer ontology; generating lists of compounds required to produce a desired aroma accurately and cost effectively; scent marketing/olfactory branding; and so forth.

Example embodiments of the invention can also be used to enhance a wide range of disciplines involving human olfactory responses. For example, in the field of appetite management, odors have been shown to affect appetite and can be used in weight control as well as appetite management in chemotherapy patients. Example embodiments of the invention can provide an understanding of the scents/odors associated with increased and decreased food consumption, which can make it possible for food manufacturers, food purveyors, dietary organizations, or the like to more effectively manage human appetite. As another example, example embodiments of the invention have applicability in the field of odor cancellation. For example, the predictive capabilities of example embodiments can be used to determine which compounds when combined together would result in neutral scents. Such an application could aid in making environments or products with unpleasant odors more appealing or engaging (e.g., public restrooms). Example embodiments also have applicability in the field of lossy compression, where they can be used to determine, from a set of compounds having a known scent, a subset of compounds or different compounds that produce the same aroma more simply or cost-effectively.

In addition, example embodiments have applicability in the field of virtual reality (VR). Conventional VR uses auditory and visual cues, but not olfactory cues. The ability to generate odor within a VR based on environmental cues could be provided based on example embodiments of the invention. Further, the field of affective computing (computing based on user emotion) currently uses data from wearable devices, but does not incorporate olfactory response data. Example embodiments of the invention can provide olfactory response data that can improve affective computing capabilities. In addition, example embodiments of the invention can be used to increase overall human health because the sense of smell, for example, has been linked to mortality and morbidity. For example, correlations between sense of smell and genetics could be used as a cost-effective screen to identify potential matches for organ or bone marrow transplants. It should be appreciated that the above examples of potential areas of applicability of example embodiments of the invention are merely illustrative and not exhaustive.

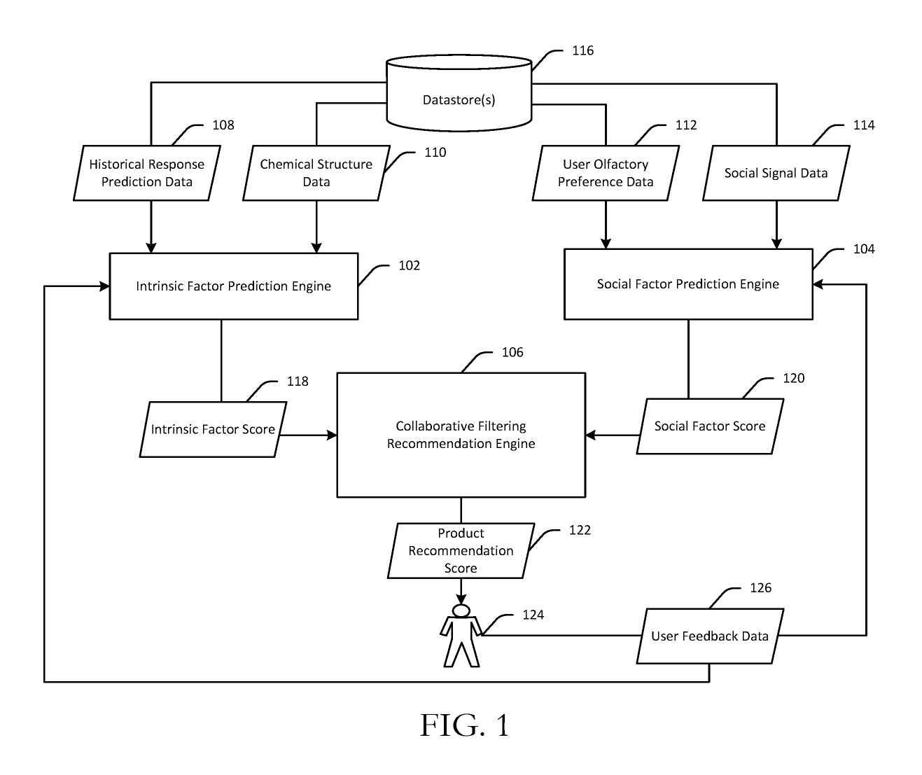

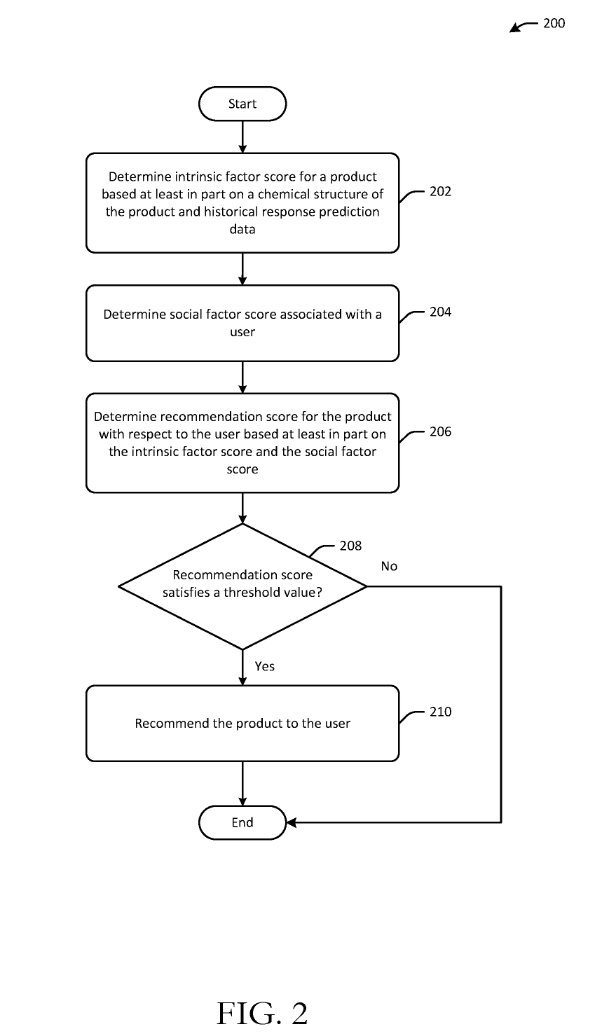

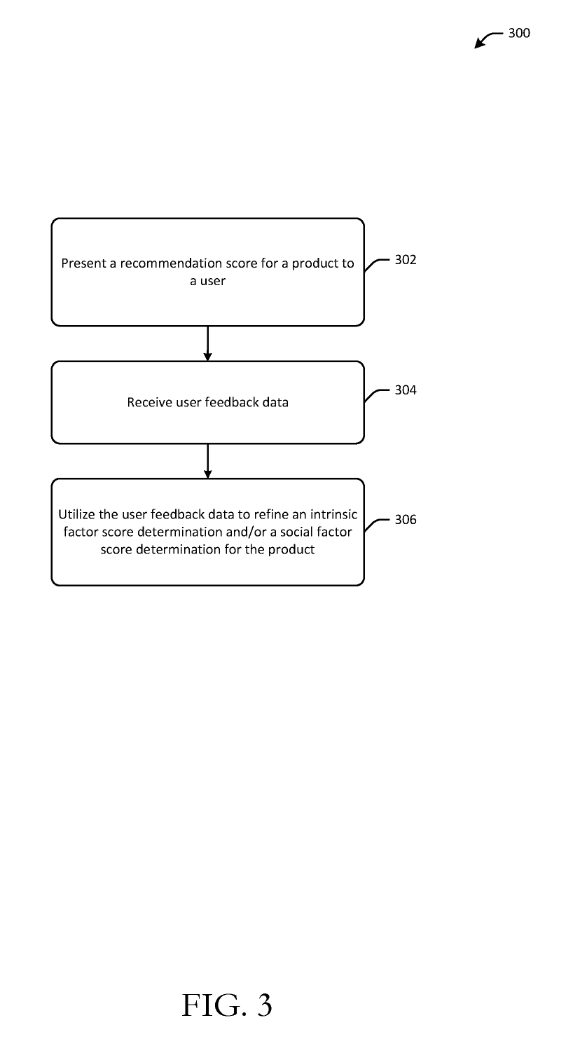

Turning now to a more detailed description of aspects of the present invention, FIG. 1 is a schematic data flow and block diagram depicting the generation of a product recommendation score for a product with respect to a user based on intrinsic olfactory characteristics of the product as well as extrinsic factors predictive of the user's olfactory response to the product in accordance with one or more example embodiments. FIG. 2 is a process flow diagram of an illustrative method 200 for generating and presenting a product recommendation score for a product to a user in accordance with one or more example embodiments of the invention. FIG. 3 is a process flow diagram of an illustrative method 300 for refining a predicted olfactory response to a product using user feedback data in accordance with one or more example embodiments of the invention. FIGS. 2 and 3 will each be described herein in conjunction with FIG. 1.

Each operation of the method 200 and/or the method 300 can be performed by one or more components depicted in FIG. 1. These component(s) can be implemented in any combination of hardware, software, and/or firmware. In certain example embodiments, one or more of these component(s) can be implemented, at least in part, as software and/or firmware that contains or is a collection of one or more program modules that include computer-executable instructions that when executed by a processing circuit cause one or more operations to be performed. A system or device described herein as being configured to implement example embodiments of the invention can include one or more processing circuits, each of which can include one or more processing units or nodes. Computer-executable instructions can include computer-executable program code that when executed by a processing unit can cause input data contained in or referenced by the computer-executable program code to be accessed and processed to yield output data.

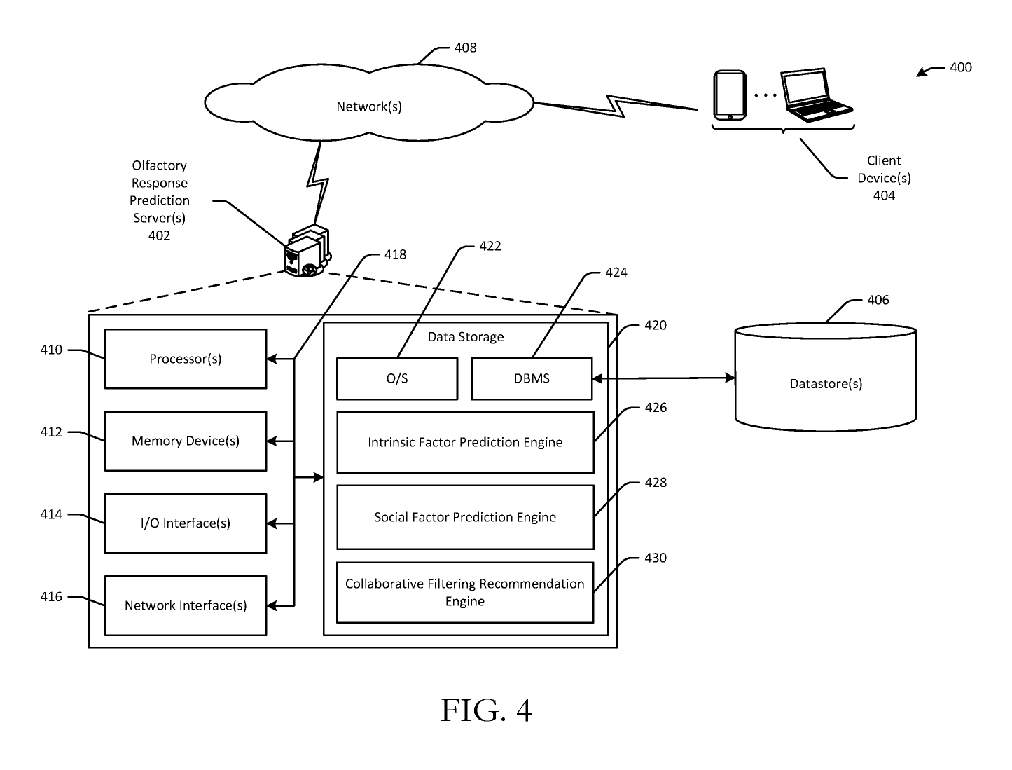

Referring first to FIG. 1, various computing engines are depicted including an intrinsic factor prediction engine 102, a social factor prediction engine 104, and a collaborative filtering recommendation engine 106. These engines can be implemented in any combination of software, firmware, and/or hardware. One or more of these engines can be executable across one or more olfactory response prediction servers having the illustrative configuration depicted in FIG. 4, which will be described later in this description.

FIG. 1 also depicts one or more datastores 116 that can store a variety of types of data including, without limitation, historical response prediction data 108, chemical structure data 110, user olfactory preference data 112, and social signal data 114. The chemical structure data 110 can include, for example, data that indicates an intrinsic association between olfactory characteristics and consumer products based on chemical structures of the consumer products. For example, a certain chemical structure (e.g., a specific arrangement of elements and chemical bonds between the elements) can have a known olfactory attribute (e.g., flowery scent). More specifically, olfactory receptors in a human nose, for example, can bind a molecule having a certain chemical structure, which can stimulate a signal in the brain that causes a particular olfactory characteristic to be detected. As such, the chemical structure data 110 can associate such an olfactory characteristic with each product containing the corresponding chemical structure. In certain example embodiments, a combination of various chemical structural components can be known to have a certain olfactory characteristic, in which case, the chemical structure data 110 can associate products containing that combination with that olfactory characteristic.

Further, in certain example embodiments, the chemical structure data 110 can include a ground-truth dataset that indicates—for a predetermined baseline set of molecules and a predetermined set of olfactory descriptors—which subset of descriptors a sampling of individuals have associated with each molecule. The set of molecules can include different chemical structures that cover a broad swath of consumer products containing such chemical structures. The set of olfactory descriptors can include, without limitation, such descriptors as bakery, sweat, fruit, fish, garlic, spices, cold, sour, burnt, acid, warm, musky, sweaty, ammonia, decayed, wood, grass, floral, chemical, and so forth.

The historical response prediction data 108 can include data indicative of historical patterns or trends in consumer responses to particular olfactory characteristics. For example, the historical response prediction data 108 can indicate that, among some aggregate number of consumers, there is a trend towards responding favorably to a particular olfactory characteristic (e.g., a sweet taste, a floral scent, etc.) or a trend towards responding negatively to some other olfactory characteristic (e.g., a bitter taste, a pungent odor, etc.).

The user olfactory preference data 112 can include, without limitation, user olfactory preference seed data, user rating data, or the like. User olfactory preference seed data for a given consumer can include an initial rating or survey of the consumer's preferences with respect to various odors, products, and/or environments. The user rating data for a given consumer can include data indicative of how the consumer has characterized olfactory attributes of various products using, for example, the example set of descriptors described earlier.

The social signal data 114 for a given user can include, without limitation, social networking data that indicates products (or specific olfactory characteristics) that the user has indicated positive or negative sentiment towards; data that indicates products that the user has recommended to others or that have been recommended to the user by others; data indicative of olfactory characteristics that have served as a basis for product recommendations by or to the user; data that indicates cultural or regional preferences or dislike for certain olfactory characteristics; user fitness data that signals a general class of products that might be preferred by the user; weather data that can be correlated with certain olfactory characteristics; and so forth.

Referring now to FIGS. 1 and 2 in conjunction with one another, at block 202, computer-executable instructions of the intrinsic factor prediction engine 102 can be executed to determine an intrinsic factor score 118 for a product. The intrinsic factor prediction engine 102 can determine the intrinsic factor score 118 based at least in part on at least a portion of the historical response prediction data 108 and at least a portion of the chemical structure data 110. More specifically, the intrinsic factor prediction engine 102 can determine a chemical structure of the product, determine olfactory characteristics of the product based on associations present in the chemical structure data 110 between olfactory characteristics and chemical structures, and predict consumer response to the olfactory characteristics of the product using the historical response prediction data 108.

For example, the intrinsic factor prediction engine 102 can determine that the product contains a particular type of molecule (or a particular chemical arrangement such as a carboxylic group) and can determine, from the chemical structure data 110, one or more olfactory characteristics known to be associated with that particular type of molecule or chemical arrangement. The intrinsic factor prediction engine 102 can then associate those one or more olfactory characteristics with the product and predict a response of a user 124 to those olfactory characteristic(s) based on historical response prediction data 108 indicative of an aggregate consumer response to such characteristic(s).

At block 204, computer-executable instructions of the social factor prediction engine 104 can be executed to determine a social factor score 120 associated with the user 124. The social factor prediction engine 104 can determine the social factor score 120 based at least in part on user olfactory preference data 112 associated with the user 124 and/or social signal data 114 associated with the user 124. The user olfactory preference data 112 associated with the user 124 can include, for example, preferences the user 124 has previously indicated towards various olfactory attributes, user ratings that the user 124 has previously provided for other products that share similarities in chemical structure with the product under consideration, or the like. The social signal data 114 associated with the user 124 can include, for example, social networking data that indicates products (or specific olfactory characteristics) that the user 124 has indicated positive or negative sentiment towards; data that indicates products that the user 124 has recommended to others or that have been recommended to the user by others; data indicative of olfactory characteristics that have served as a basis for product recommendations by or to the user 124; user fitness data that signals a general class of products that might be preferred by the user 124; weather data that can be correlated with certain olfactory characteristics; and so forth.

In certain example embodiments, a baseline social factor score can be adjusted upwards or downwards based at least in part on the user olfactory preference data 112 and/or the social signal data 114 to determine the social factor score 120 for the user 124. For instance, in certain example embodiments, a set of olfactory characteristics determined to be associated with the product under consideration can be compared to a set of olfactory characteristics predicted to elicit a positive response from the user 124 based on the user olfactory preference data 112 and/or the social signal data 114. A number of olfactory characteristics in common between these two sets can then be identified, and the social factor prediction engine 104 can be configured to increase the baseline social factor score if it determines that the number of common olfactory characteristics satisfies a threshold value (e.g., is greater than or equal to the threshold value). In other example embodiments, the set of olfactory characteristics determined to be associated with the product under consideration can be compared to a set of olfactory characteristics predicted to elicit a negative response from the user 124 to determine a number of common olfactory characteristics, and if this number satisfies a threshold value, the social factor prediction engine 104 can be configured to correspondingly decrease the baseline social factor score.

At block 206, computer-executable instructions of the collaborative filtering recommendation engine 106 can be execute to determine a product recommendation score 122 for the product under consideration with respect to the user 124 based at least in part on the intrinsic factor score 118 and the social factor score 120. In an example embodiment of the invention, the product recommendation score 122 can be a single quantitative measure that represents a weighted combination of the intrinsic factor score 118 and the social factor score 120. As a non-limiting example, the product recommendation score 122 can be a weighted average of the intrinsic factor score 118 and the social factor score 120. For instance, if x and y represent the intrinsic factor score 118 and the social factor score 120, respectively, then the product recommendation score 122 can be given by the function f (x,y)=(ax+by)/(a+b), where a and b represent the weights applied to the intrinsic factor score 118 and the social factor score 120, respectively. In certain example embodiments, the weights a and b can be real numbers between 0 and 1 inclusive. Further, in certain example embodiments, the weights can be learned by using a set of olfactory characteristics known to be preferred by the user 124 (or a set of products having such olfactory characteristics) and maximizing the scores generated for such preferred characteristics (or products having such characteristics). The collaborative filtering recommendation engine 106 can employ Bayesian networks, Boolean logic networks, neural networks, or any other suitable machine learning technique to determine the product recommendation score 122.

At block 208, computer-executable instructions of the collaborative filtering recommendation engine 106 can be executed to determine whether the product recommendation score 122 satisfies a threshold value. The threshold value can be a predetermined value applicable to a group of users who exhibit similar olfactory preferences or can be a value tailored to the user's 124 specific olfactory preferences. In certain example embodiments, the user 124 can set the threshold value based on his/her desired precision in identifying products having olfactory characteristics that the user 124 is likely to respond in a positive manner towards. In response to a positive determination at block 208, computer-executable instructions of the collaborative filtering recommendation engine 106 can be executed to cause the product to be recommended to the user 124 at block 210. Recommending the product to the user 124 can include presenting an indication of the product recommendation score 122 to the user 124. On the other hand, in response to a negative determination at block 208, the method 200 can end without the product being recommended to the user 124.

Product recommendation scores determined for products with respect to the user 124 can enable automated ordering of products predicted to have preferred olfactory characteristics for the user 124. For example, the user 124 can establish application settings that enable the automated ordering of products having product recommendation scores that satisfy a desired threshold score. Product recommendation scores can also provide valuable feedback to manufacturers or other interested entities on user preferences for their products based on olfactory characteristics of the products.

FIG. 3 is a process flow diagram of an illustrative method 300 for refining a predicted olfactory response to a product using user feedback data in accordance with one or more example embodiments of the invention. Referring to FIGS. 1 and 3 in conjunction with one another, at block 302, computer-executable instructions of the collaborative filtering recommendation engine 106 can be executed to cause the product recommendation score 122 to be presented to the user 124. The method 200 described earlier indicates that the product recommendation score is only presented to the user 124 if it satisfies a threshold value (is greater than or equal to the threshold value or is less than or equal to the threshold value depending on the implementation). However, in certain example embodiments of the invention, the product recommendation score 122 can be presented to the user 124 regardless of whether the score 122 is determined to satisfy the threshold value.

At block 304, user feedback data 126 is received from the user 124. The user feedback data 126 can include an indication of the user's 124 perception of the accuracy of the product recommendation score 122. The user feedback data 126 can additionally, or alternatively, include a rating or other indication of the user's 124 preference towards olfactory characteristics of the product; data indicative of additional olfactory characteristics that the user 124 would associate with the product or olfactory characteristics that the user 124 would disassociate from the product; and so forth.

At block 306, the user feedback data 126 can be utilized to, for example, refine the determination of the intrinsic factor score 118 and/or the determination of the social factor score 120. For example, the intrinsic factor prediction engine 102 can adjust the intrinsic factor score 118 for the product upwards if the user feedback data 126 indicates positive user sentiment towards intrinsic olfactory characteristics of the product or can adjust the intrinsic factor score 118 for the product downwards if the user feedback data 126 indicates negative user sentiment. As another example, the social factor prediction engine 104 can adjust the social factor score 120 upwards or downwards for the user 124 based at least in part on the user feedback data 126. Further, in certain example embodiments, the collaborative filtering recommendation engine 106 can adjust the product recommendation score 122 based at least in part on the user feedback data 126. For example, the collaborative filtering recommendation engine 106 can adjust one or both of the weights applied to the intrinsic factor score 118 and the social factor score 120 based on the user feedback data 126.

Example embodiments of the invention provide various technical features, technical effects, and/or improvements to technology. For instance, example embodiments of the invention provide the technical effects of predicting a user's response to olfactory characteristics of a product and determining whether to recommend the product based on the prediction. These technical effects are achieved by at least in part by the technical features of determining an intrinsic factor score for a product based at least in part on its chemical structure, determining a social factor score associated with the user, and applying collaborative filtering techniques to determine a product recommendation score using both the intrinsic factor score and the social factor score. These technical effects constitute an improvement to the functioning of a computer configured to provide automated predictions of olfactory responses of users to products. It should be appreciated that the above examples of technical features, technical effects, and improvements to the functioning of a computer and computer technology provided by example embodiments of the invention are merely illustrative and not exhaustive.

One or more illustrative embodiments of the invention are described herein. Such embodiments are merely illustrative of the scope of this invention and are not intended to be limiting in any way. Accordingly, variations, modifications, and equivalents of embodiments described herein are also within the scope of the invention.

FIG. 4 is a schematic diagram of an illustrative networked architecture 400 in accordance with one or more example embodiments of the invention. The networked architecture can include one or more olfactory response prediction servers 402 that are configured to communicate with one or more client devices 404 over one or more networks 408. While one or more components of the networked architecture 400 are described herein in the singular at times, it should be appreciated that multiple instances of any such component can be provided, and functionality described in connection with a particular component can instead be distributed across such multiple instances.

The client device(s) 404 can include, without limitation, a smartphone, a tablet, a wearable device, a personal computer, or any other suitable user device. The network(s) 408 can include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. The network(s) 408 can have any suitable communication range associated therewith and can include, for example, global networks (e.g., the Internet), metropolitan area networks (MANs), wide area networks (WANs), local area networks (LANs), or personal area networks (PANs). In addition, the network(s) 408 can include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the olfactory response prediction server 402 can include one or more processors (processor(s)) 410, one or more memory devices 412 (generically referred to herein as memory 412), one or more input/output (“I/O”) interface(s) 414, one or more network interfaces 416, and data storage 420. The olfactory response prediction server 402 can further include one or more buses 418 that functionally couple various components of the olfactory response prediction server 402.

The bus(es) 418 can include at least one of a system bus, a memory bus, an address bus, or a message bus, and can permit the exchange of information (e.g., data (including computer-executable code), signaling, etc.) between various components of the olfactory response prediction server 402. The bus(es) 418 can include, without limitation, a memory bus or a memory controller, a peripheral bus, an accelerated graphics port, and so forth. The bus(es) 418 can be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

The memory 412 can include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, can include non-volatile memory. In certain example embodiments, volatile memory can enable faster read/write access than non-volatile memory. However, in certain other example embodiments, certain types of non-volatile memory (e.g., FRAM) can enable faster read/write access than certain types of volatile memory.

In various implementations, the memory 412 can include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 412 can include main memory as well as various forms of cache memory such as instruction cache(s), data cache(s), translation lookaside buffer(s) (TLBs), and so forth. Further, cache memory such as a data cache can be a multi-level cache organized as a hierarchy of one or more cache levels (L1, L2, etc.).

The data storage 420 can include removable storage and/or non-removable storage including, but not limited to, magnetic storage, optical disk storage, and/or tape storage. The data storage 420 can provide non-volatile storage of computer-executable instructions and other data. The memory 412 and the data storage 420, removable and/or non-removable, are examples of computer-readable storage media (CRSM) as that term is used herein.

The data storage 420 can store computer-executable code, instructions, or the like that can be loadable into the memory 412 and executable by the processor(s) 410 to cause the processor(s) 410 to perform or initiate various operations. The data storage 420 can additionally store data that can be copied to memory 412 for use by the processor(s) 410 during the execution of the computer-executable instructions. Moreover, output data generated as a result of execution of the computer-executable instructions by the processor(s) 410 can be stored initially in memory 412 and can ultimately be copied to data storage 420 for non-volatile storage.

More specifically, the data storage 420 can store one or more operating systems (O/S) 422; one or more database management systems (DBMS) 424 configured to access the memory 412 and/or one or more external datastore(s) 406; and one or more program modules, applications, engines, computer-executable code, scripts, or the like such as, for example, an intrinsic factor prediction engine 426, a social factor prediction engine 428, and a collaborative filtering recommendation engine 428. Any of the components depicted as being stored in data storage 420 can include any combination of software, firmware, and/or hardware. The software and/or firmware can include computer-executable instructions (e.g., computer-executable program code) that can be loaded into the memory 412 for execution by one or more of the processor(s) 410 to perform any of the operations described earlier in connection with correspondingly named modules. In certain example embodiments, the client device(s) 404 can be configured to communicate with the olfactory response prediction server 402 to obtain results of processing performed by the depicted engines. In other example embodiments, one or more of the depicted engines can reside, at least partially, on a client device 404 as part of a client application executable on the client device 404, for example.

Although not depicted in FIG. 4, the data storage 420 can further store various types of data utilized by components of the olfactory response prediction server 402 (e.g., any of the types of data depicted in and described with respect to FIG. 1). Any data stored in the data storage 420 can be loaded into the memory 412 for use by the processor(s) 410 in executing computer-executable instructions. In addition, any data stored in the data storage 420 can potentially be stored in the datastore(s) 406 (which can include the datastore(s) 116) and can be accessed via the DBMS 424 and loaded in the memory 412 for use by the processor(s) 410 in executing computer-executable instructions.

The processor(s) 410 can be configured to access the memory 412 and execute computer-executable instructions loaded therein. For example, the processor(s) 410 can be configured to execute computer-executable instructions of the various program modules, applications, engines, or the like of the olfactory response prediction server 402 to cause or facilitate various operations to be performed in accordance with one or more embodiments of the invention. The processor(s) 410 can include any suitable processing unit capable of accepting data as input, processing the input data in accordance with stored computer-executable instructions, and generating output data. The processor(s) 410 can include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 410 can have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 410 can be capable of supporting any of a variety of instruction sets.

Referring now to other illustrative components depicted as being stored in the data storage 420, the O/S 422 can be loaded from the data storage 420 into the memory 412 and can provide an interface between other application software executing on the olfactory response prediction server 402 and hardware resources of the olfactory response prediction server 402. More specifically, the 0/S 422 can include a set of computer-executable instructions for managing hardware resources of the olfactory response prediction server 402 and for providing common services to other application programs. In certain example embodiments, the O/S 422 can include or otherwise control execution of one or more of the program modules depicted as being stored in the data storage 420. The O/S 422 can include any operating system now known or which can be developed in the future including, but not limited to, any server operating system, any mainframe operating system, or any other proprietary or non-proprietary operating system.

The DBMS 424 can be loaded into the memory 412 and can support functionality for accessing, retrieving, storing, and/or manipulating data stored in the memory 412, data stored in the data storage 420, and/or data stored in the datastore(s) 406. The DBMS 424 can use any of a variety of database models (e.g., relational model, object model, etc.) and can support any of a variety of query languages. The DBMS 424 can access data represented in one or more data schemas and stored in any suitable data repository. The datastore(s) 406 can include, but are not limited to, databases (e.g., relational, object-oriented, etc.), file systems, flat files, distributed datastores in which data is stored on more than one node of a computer network, peer-to-peer network datastores, or the like.

Referring now to other illustrative components of the olfactory response prediction server 402, the input/output (I/O) interface(s) 414 can facilitate the receipt of input information by the olfactory response prediction server 402 from one or more I/O devices as well as the output of information from the olfactory response prediction server 402 to the one or more I/O devices. The I/O devices can include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components can be integrated into the olfactory response prediction server 402 or can be separate. The I/O devices can further include, for example, any number of peripheral devices such as data storage devices, printing devices, and so forth.

The I/O interface(s) 414 can also include an interface for an external peripheral device connection such as universal serial bus (USB), FireWire, Thunderbolt, Ethernet port or other connection protocol that can connect to one or more networks. The I/O interface(s) 414 can also include a connection to one or more antennas to connect to one or more networks via a wireless local area network (WLAN) (such as Wi-Fi) radio, Bluetooth, and/or a wireless network radio, such as a radio capable of communication with a wireless communication network such as a Long Term Evolution (LTE) network, WiMAX network, 3G network, etc.

The olfactory response prediction server 402 can further include one or more network interfaces 416 via which the olfactory response prediction server 402 can communicate with any of a variety of other systems, platforms, networks, devices, and so forth. The network interface(s) 416 can enable communication, for example, with one or more client devices 404 via one or more of the network(s) 408.

It should be appreciated that the engines depicted in FIG. 4 as being stored in the data storage 420 are merely illustrative and not exhaustive and that processing described as being supported by any particular engine can alternatively be distributed across multiple modules, engines, or the like, or performed by a different module, engine, or the like. In addition, various program module(s), script(s), plug-in(s), Application Programming Interface(s) (API(s)), or any other suitable computer-executable code hosted locally on the olfactory response prediction server 402 and/or hosted on other computing device(s) accessible via one or more of the network(s) 408, can be provided to support functionality provided by the engines depicted in FIG. 4 and/or additional or alternate functionality. Further, functionality can be modularized in any suitable manner such that processing described as being performed by a particular engine can be performed by a collection of any number of engines or program modules, or functionality described as being supported by any particular engine can be supported, at least in part, by another engine. In addition, engines that support the functionality described herein can be executable across any number of devices 402 in accordance with any suitable computing model such as, for example, a client-server model, a peer-to-peer model, and so forth. In addition, any of the functionality described as being supported by any of the engines depicted in FIG. 4 can be implemented, at least partially, in hardware and/or firmware across any number of devices.

It should further be appreciated that the olfactory response prediction server 402 can include alternate and/or additional hardware, software, or firmware components beyond those described or depicted without departing from the scope of the invention. More particularly, it should be appreciated that software, firmware, or hardware components depicted as forming part of the olfactory response prediction server 402 are merely illustrative and that some components can be absent or additional components can be provided in various embodiments. While various illustrative engines have been depicted and described as software modules stored in data storage 420, it should be appreciated that functionality described as being supported by the engines can be enabled by any combination of hardware, software, and/or firmware. It should further be appreciated that each of the above-mentioned engines represents, in various embodiments, a logical partitioning of supported functionality. This logical partitioning is depicted for ease of explanation of the functionality and is not necessarily representative of the structure of software, hardware, and/or firmware for implementing the functionality. Accordingly, it should be appreciated that functionality described as being provided by a particular engine can, in various embodiments, be provided at least in part by one or more other engines. Further, one or more depicted engines can be absent in certain embodiments, while in other embodiments, additional program modules and/or engines not depicted can be present and can support at least a portion of the described functionality and/or additional functionality.

One or more operations of the method 200 or the method 300 can be performed by an olfactory response prediction server 402 having the illustrative configuration depicted in FIG. 4, or more specifically, by one or more program modules, engines, applications, or the like executable on such a device. It should be appreciated, however, that such operations can be implemented in connection with numerous other device configurations.

The operations described and depicted in the illustrative method 200 of FIG. 2 or the illustrative method 300 of FIG. 3 can be carried out or performed in any suitable order as desired in various example embodiments of the invention. Additionally, in certain example embodiments, at least a portion of the operations can be carried out in parallel. Furthermore, in certain example embodiments, less, more, or different operations than those depicted in FIG. 2 or FIG. 3 can be performed.

Although specific embodiments of the invention have been described, one of ordinary skill in the art will recognize that numerous other modifications and alternative embodiments are within the scope of the invention. For example, any of the functionality and/or processing capabilities described with respect to a particular system, system component, device, or device component can be performed by any other system, device, or component. Further, while various illustrative implementations and architectures have been described in accordance with embodiments of the invention, one of ordinary skill in the art will appreciate that numerous other modifications to the illustrative implementations and architectures described herein are also within the scope of this invention. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

The present invention can be a system, a method, and/or a computer program product. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for predicting a response to olfactory characteristics of a stimulus, the method comprising:
determining an intrinsic factor score for the stimulus based at least in part on an intrinsic attribute of the stimulus;
determining a social factor score associated with a user, wherein the social factor score is indicative of a predicted response of the user to the olfactory characteristics of the stimulus, wherein determining the social factor score comprises determining the social factor score based at least in part on social signal data indicative of cultural or regional preferences or dislike for the olfactory characteristics of the stimulus;
determining a number of common olfactory characteristics between the olfactory characteristics of the stimulus and a set of olfactory characteristics predicted to elicit a positive response from the user;
determining that the number of common olfactory characteristics satisfies a first threshold value; and
increasing the social factor score;
determining a recommendation score for the stimulus with respect to the user based at least in part on the intrinsic factor score and the social factor score;
determining that the recommendation score satisfies a second threshold value, wherein the second threshold value is set based at least in part on a desired precision in identifying stimuli with olfactory characteristics desirable to the user; and
sending, to a client application executing on a user device operable by the user, a message that recommends the stimulus to the user.

2. The computer-implemented method of claim 1, wherein the message comprises the recommendation score.

3. The computer-implemented method of claim 1, wherein the stimulus is a first stimulus and the recommendation score is a first recommendation score, the method further comprising:
determining a second recommendation score for a second stimulus with respect to the user;
providing an indication of the second recommendation score to the user that is accessible via a user profile associated with the user, wherein the client application is logged into the user profile;
receiving, from the user, user feedback data indicative of an accuracy of the second recommendation score; and
updating the second recommendation score based at least in part on the user feedback data.

4. The computer-implemented method of claim 1, wherein the stimulus is a product and the intrinsic attribute is a chemical structure of the product.

5. The computer-implemented method of claim 4, wherein determining the intrinsic factor score for the product further comprises determining the intrinsic factor score based at least in part on data indicative of historical consumer response to at least one of the product or another product having a chemical structure similar to the chemical structure of the product.

6. The computer-implemented method of claim 1, further comprising identifying user olfactory preference data associated with the user, wherein the user olfactory preference data is indicative of olfactory preferences of the user, and wherein determining the social factor score comprises determining the social factor score based at least in part on the user olfactory preference data.

7. The computer-implemented method of claim 6, wherein the olfactory characteristics are a first set of olfactory characteristics, and wherein determining the social factor score comprises:
determining, based at least in part on the user olfactory preference data, a second set of olfactory characteristics for which the user has demonstrated positive sentiment;
determining that the first set of olfactory characteristics and the second set of olfactory characteristics comprise a threshold number of common olfactory characteristics; and
increasing the social factor score.

8. The computer-implemented method of claim 1, wherein determining the social factor score comprises determining the social factor score based at least in part on one or more social signals associated with the user.

9. A system for predicting a response to a stimulus based on olfactory characteristics of the stimulus, the system comprising:
at least one memory storing computer-executable instructions; and
at least one processor configured to access the at least one memory and execute the computer-executable instructions to:
determine an intrinsic factor score for the stimulus based at least in part on an intrinsic attribute of the stimulus;
determine a social factor score associated with a user, wherein the social factor score is indicative of a predicted response of the user to the olfactory characteristics of the stimulus, wherein determining the social factor score comprises determining the social factor score based at least in part on social signal data indicative of cultural or regional preferences or dislikes for the olfactory characteristics of the stimulus;
determine a number of common olfactory characteristics between the olfactory characteristics of the stimulus and a set of olfactory characteristics predicted to elicit a positive response from the user;
determine that the number of common olfactory characteristics satisfies a first threshold value; and
increase the social factor score;
determine a recommendation score for the stimulus with respect to the user based at least in part on the intrinsic factor score and the social factor score;
determine that the recommendation score satisfies a second threshold value, wherein the second threshold value is set based at least in part on a desired precision in identifying stimuli with olfactory characteristics desirable to the user; and
send, to a client application executing on a user device operable by the user, a message that recommends the stimulus to the user.

10. The system of claim 9, wherein the message comprises the recommendation score.

11. The system of claim 9, wherein the stimulus is a first stimulus and the recommendation score is a first recommendation score, and wherein the at least one processor is further configured to execute the computer-executable instructions to:
determine a second recommendation score for a second stimulus with respect to the user;
provide an indication of the second recommendation score to the user that is accessible via a user profile associated with the user, wherein the client application is logged into the user profile;
receive, from the user, user feedback data indicative of an accuracy of the second recommendation score; and
update the second recommendation score based at least in part on the user feedback data.

12. The system of claim 9, wherein the stimulus is a product and the intrinsic attribute is a chemical structure of the product.

13. The system of claim 12, wherein the at least one processor is configured to determine the intrinsic factor score for the product by executing the computer-executable instructions to determine the intrinsic factor score further based at least in part on data indicative of historical consumer response to at least one of the product or another product having a chemical structure similar to the chemical structure of the product.

14. The system of claim 9, wherein the at least one processor is further configured to executable the computer-executable instructions to identify user olfactory preference data associated with the user, wherein the user olfactory preference data is indicative of olfactory preferences of the user, wherein the at least one processor is configured to determine the social factor score by executing the computer-executable instructions to determine the social factor score based at least in part on the user olfactory preference data.

15. The system of claim 14, wherein the olfactory characteristics are a first set of olfactory characteristics, and wherein the at least one processor is configured to determine the social factor score by executing the computer-executable instructions to:
determine, based at least in part on the user olfactory preference data, a second set of olfactory characteristics for which the user has demonstrated positive sentiment;
determine that the first set of olfactory characteristics and the second set of olfactory characteristics comprise a threshold number of common olfactory characteristics; and
increase the social factor score.

16. A computer program product for predicting a response to a stimulus based on olfactory characteristics of the stimulus, the computer program product comprising a non-transitory storage medium readable by a processing circuit, the storage medium storing instructions executable by the processing circuit to cause a method to be performed, the method comprising:
determining an intrinsic factor score for the stimulus based at least in part on an intrinsic attribute of the stimulus;
determining a social factor score associated with a user, wherein the social factor score is indicative of a predicted response of the user to the olfactory characteristics of the stimulus, wherein determining the social factor score comprises determining preferences or dislikes for the olfactory characteristics of the stimulus;
determining a number of common olfactory characteristics between the olfactory characteristics of the stimulus and a set of olfactory characteristics predicted to elicit a positive response from the user;
determining that the number of common olfactory characteristics satisfies a first threshold value; and
increasing the social factor score;
determining a recommendation score for the stimulus with respect to the user based at least in part on the intrinsic factor score and the social factor score;
determining that the recommendation score satisfies a second threshold value, wherein the second threshold value is set based at least in part on a desired precision in identifying stimuli with olfactory characteristics desirable to the user; and
sending, to a client application executing on a user device operable by the user, a message that recommends the stimulus to the user.

17. The computer program product of claim 16, wherein the message comprises the recommendation score.

18. The computer program product of claim 16, wherein the stimulus is a first stimulus and the recommendation score is a first recommendation score, the method further comprising:
determining a second recommendation score for a second stimulus with respect to the user;
providing an indication of the second recommendation score to the user that is accessible via a user profile associated with the user, wherein the client application is logged into the user profile;
receiving, from the user, user feedback data indicative of an accuracy of the second recommendation score; and
updating the second recommendation score based at least in part on the user feedback data.

19. The computer program product of claim 16, wherein the stimulus is a product and the intrinsic attribute is a chemical structure of the product.

20. The computer program product of claim 19, wherein determining the intrinsic factor score for the product further comprises determining the intrinsic factor score based at least in part on data indicative of historical consumer response to at least one of the product or another product having a chemical structure similar to the chemical structure of the product.
